(19) United States
(12) Patent Application Publication
(10) Pub. No.: US 2022/0298712 A1
(43) Pub. Date: Sep. 22, 2022

(54) NEW FILTER, FILTER UNIT, TREATMENT APPARATUS, METHOD AND USE

(71) Applicant: Xeros Limited, Rotherham, South Yorkshire (GB)

(72) Inventors: Joseph MATTLEY, Rotherham, South Yorkshire (GB); James Richard PEASE, Rotherham, South Yorkshire (GB); Thomas Andrew COBB, Rotherham, South Yorkshire (GB); Gareth Evan Lyn JONES, Bath and North East Somerset (GB)

(73) Assignee: Xeros Limited, Rotherham, South Yorkshire (GB)

(21) Appl. No.: 17/634,396

(22) PCT Filed: Aug. 20, 2020
(86) PCT No.: PCT/GB2020/052001

§ 371 Date: Feb. 10, 2022

(30) Foreign Application Priority Data
Aug. 21, 2019 (GB) 1911997.3

(51) Int. Cl. D06F 39/10; B01D 33/11; B01D 33/68; B01D 33/72

(52) U.S. Cl. CPC D06F 39/10; B01D 33/11; B01D 33/68; B01D 33/727; B01D 2221/02; B01D 2201/184; B01D 2201/285

(57) ABSTRACT

This invention relates to a filter which is especially for filtering microfibres which can, for example, originate from the washing of textiles. The filter is rotatable around an axis of rotation. The filter provides good filtering efficiency and improved resistance to blocking.

### FIELD OF THE INVENTION

The present invention relates to a filter, especially to a filter suitable for filtering microfibres which can, for example, originate from the washing of textiles. The present invention further relates to a filter unit comprising said filter, to a treatment apparatus (especially a washing machine) comprising said filter unit, and to a method or use employing said filter or filter unit.

### BACKGROUND TO THE INVENTION

Conventional methods for treating and cleaning of textiles and fabrics typically involve aqueous cleaning using large volumes of water. These methods generally involve aqueous submersion of fabrics followed by soil removal, aqueous soil suspension, and water rinsing. The use of solid particles to provide improvements in, and advantages over, these conventional methods is known in the art. For example PCT patent publication WO2007/128962 discloses a method for cleaning a soiled substrate using a multiplicity of solid particles. Other PCT patent publications which have related disclosures of cleaning methods include: WO2012/056252; WO2014/006424; WO2015/004444; WO2014/147391; WO2014/006425; WO 2012/035343 and WO2012/167545.

However, in conventional methods that use large volumes of water and in methods using solid particles, there remains a problem of adequate removal of solid waste fibres and particles derived from the substrate, such as lint, prior to the effluent liquid from such methods going to a drain. In particular, treating, such as washing, of clothing derived from synthetic material, such as acrylic, nylon and polyester, can result in microscopic particles or fibres being removed from the clothing and taken with effluent liquid to the drain. Microfibres of synthetic material can then reach waterways where they can negatively impact on river and marine life. With the rising appreciation of the potential damage caused to rivers, lakes, seas and oceans by the presence of waste plastic material, there is an increasing requirement to significantly reduce or eliminate solid material from being allowed to enter drainage and sewage systems. The United Nations Goal 14 includes the target of preventing and significantly reducing marine pollution of all kinds including marine debris and nutrient pollution, in particular from land-based activities.

PCT patent publication WO2019/122862 discloses a centrifugal filter unit for an apparatus which is especially suitable for using in a treatment apparatus such as a washing machine. The filter unit is especially suitable for filtering solid materials such as fibres which may originate from, for example, the cleaning of a textile substrate.

Whilst PCT publication WO2019/122862 provides excellent filtration the present inventor sought to even further improve performance in one or more of the following respects:

i. to further improve the number of repeat wash cycles or total duty volume which the filter can tolerate before it becomes too full of the solid material and/or the flow rates through the filter begin to fall below desired limits;

ii. to provide a filter wherein the filter medium within the filter is less prone to blinding, that is to say that the filter can be operated in a fashion that it self-cleans the filter medium. Blinding is the accumulation of oversized solid material on the surface of the filter medium as the feed enters the filter medium, blinding can undesirably reduce feed flow rates and the overall effectiveness of the filter, it also leads to a requirement for the filter to be disassembled and cleaned;

iii. to further increase the flow rate through the filter for any given size of filter and especially for filtering particularly small solid materials present in a feed;

iv. to provide a filter where the solid material can be even more readily removed;

v. to provide a filter which is readily scalable such that it could be applied to the filtration of feeds from, for example, a domestic washing machine or from an industrial or commercial textile treatment machine;

vi. to provide a filter wherein during operation the flow of liquid over accumulated solid material is further reduced so as not to disturb the solid material;

vii. to provide a filter which is able to compact and/or partially dry the solid material whilst not causing problems with any one or more of the abovementioned desired improvements;

In pursuance of these desired improvements the present inventor arrived at a new “filter as described herein.

### SUMMARY OF THE INVENTION

According to a first aspect of the present invention there is provided a filter suitable for a filter unit, the filter being rotatable around an axis of rotation, the filter comprising:

a) a first end, a second end and one or more side walls connecting the first end of the filter and the second end of the filter, wherein the first end, second end and one or more side walls of the filter define a filter chamber;
b) an inlet located in the first end of the filter, wherein said inlet is configured to allow a feed to enter the filter chamber;

c) a filter medium having a first surface, wherein the first surface is the surface through which the feed enters the filter medium and is filtered; and

wherein one or more of the following requirements are met:

i) at least a portion of said first surface is oriented such that when the filter is operating and rotating about the axis of rotation any solid material accumulating on said first surface is urged away from said first surface;
ii) at least one of the side walls of the filter may have perforations provided that no more than 50% of the surface area of said at least one side wall is occupied by said perforations;
iii) the filter additionally comprises a flow path which is defined and constrained by one or more surfaces within the filter chamber, said flow path having at least a portion which is not coincident with the axis of rotation of the filter during operation nor is it radial with regard to the axis of rotation during operation;
iv) the filter comprises a plurality of filter media, at least some of which are stacked in layers.

It will be appreciated that the filter described herein is a centrifugal filter.

Filter Medium

The filter medium typically has perforations.

Typically, in order of increasing preference the perforations of the filter medium have an average largest dimension that is at least about 1 μm, at least about 2 μm, at least about 5 μm, at least about 10 μm, at least about 20 μm, at least about 30 μm and at least about 40 μm. Typically, the perforations of the filter medium have an average largest dimension of no more than about 2 mm, preferably no more than about 1 mm, preferably no more than about 500 μm, preferably no more than about 250 μm, more preferably no more than about 100 μm. Typically, the average largest dimension of the perforations is from about 10 μm to about 250 μm. The average is preferably an arithmetic average.

For particles of solid materials in the feed which are or comprise fibres, generally and particularly the fibres have a longest linear dimension of greater than about 1 μm and typically no longer than about 5 mm, typically no longer than about 1 mm, and these perforation dimensions provide advantageous filtration efficiencies.

Typically, at least about 50 wt %, at least about 60 wt %, at least about 70 wt %, at least about 80 wt %, at least about 90 wt %, at least about 95 wt %, or at least about 99 wt % of solid material in the feed is prevented from passing through the filter.

The weight percentage of solid material that a filter is able to prevent from being passed through may be readily measured, for example, by measuring the mass of the filter when removed from the filter unit and then mixing a known mass of solid material with a known volume of water to make a feed. The filter is then operated in the filter unit to filter the feed and remove the solid material as best it can from the feed. By removing the filter and remeasuring its mass at the end of the filtration, the mass of the collected solid can be calculated and, thus, the percentage of solid collected compared to the mass of solid mixed with water to make a feed can also be calculated.

Typically, solid material having a maximum dimension of greater than about 2 mm, of greater than about 1 mm, of greater than about 500 μm, of greater than about 200 μm, of greater than about 100 μm, of greater than about 50 μm, of greater than about 32 μm, of greater than about 10 μm, of greater than about 5 μm, or of greater than about 1 μm is prevented from passing through the filter.

The filter medium may be in the form of a sponge, a porous ceramic, a net, a woven mesh or a laminar surface with pores. The filter medium preferably comprises a single layer which preferably has pores with an average size described above.

Preferably, the filter medium is as flat as possible in shape. Thus, filters with an aspect ratio defined by their longest linear length to their depth of greater than 5:1, more preferably greater than 10:1 are preferred.

The filter medium has a first surface, wherein the first surface is the surface through which the feed enters the filter medium and is filtered. Preferably, said first surface of the filter medium is planar. The present inventor found a planar surface to be especially effective in the present invention in that solid material is less prone to blind such a surface. The operation of the filter having a filter medium with a planar surface has also been found by the present inventor to have a better ability to “self-clean.” It will be appreciated that preferably all or substantially all of the feed passes through the filter medium and is thereby filtered.

The first surface of the filter medium may optionally be corrugated, convex or concave and in which case it is preferred that at a least portion of such a surface is oriented as described in requirement i. of the first aspect of the present invention. For corrugated, convex or concave surfaces it is preferred that the amplitude of the corrugation, or the extent of convexity or concavity is relatively small such that these surfaces may be aligned or oriented as a whole with respect to the axis of rotation.

Preferably, the filter medium is planar. The filter medium itself may also optionally be corrugated, convex or concave although these shapes are less preferred. The present inventor found a planar filter medium to be especially effective in the present invention in that solid material present in the feed is less prone to blind such a filter medium. The operation of the filter having a planar filter medium has also been found by the present inventor to have a better ability to “self-clean.”

Preferably, the first surface of the filter medium is not coincident with or shared with any of the one or more side walls.

Filter media in the form of a woven mesh, a net or a laminar surface with pores are especially preferred.

A filter medium having a plurality of layers which may optionally have pores with a different average size is also possible.

The filter medium is typically attached to a filter support. The filter support is typically a rigid structure which can be made from thermoplastics, thermosets, metals, alloys, ceramics and the like. More preferably a plurality of filter media is attached to a filter support. Preferably, the filter medium or media combined with the support are substantially planar and more especially take the shape of a disc with or without cut-out portion towards the circumference of the disc.

Preferably, the filter media attached to each filter support are of equal size and more preferably are equally spaced.

A preferred arrangement for the filter media on a filter support is to have each filter taking the position of a segment of the filter where the filter support and the filter media in combination are substantially disc-shaped with or without cut-out portions towards the circumference of the disc.

The filter media and the support preferably take the form of a filter layer.

Feed

As used herein, a “feed” is the material to be filtered by the filter. Typically, the feed is a liquid comprising a solid material. Typically, the feed comprises treatment formulation that has been used in the treatment of a substrate. The amount of solid material in the feed may vary depending on the substrate being treated, the type of treatment and the stage of the treatment. As such the concentration of solid in the feed may vary considerably.

The solid material collected typically includes fibres or particles derived from the substrate (also known as “lint”), soil or a combination thereof.

Preferably, the feed is a fluid. Preferably, the feed is not in the form of a paste or semi-solid. The feed is preferably a liquid and especially an aqueous liquid. When the feed comprises liquids other than water these may be alcohols, ketones, ethers, cyclic amides and the like. Preferably, the liquid comprises at least 50 wt %, more preferably at least 80 wt % and most especially at least 90 wt % of water.

The solid material present in the feed may be in the form of particles. Preferably, the particles are or comprise fibres. The feed preferably comprises at least some fibres as the solid material. The fibres in the feed may be natural, synthetic, semi-synthetic or a mixture thereof.

For particles which are or comprise fibres, the fibres have a longest linear dimension of greater than about 1 μm and typically no longer than about 5 mm, typically no longer than about 1 mm. Fibres having a longest linear dimension of greater than about 1 μm and typically no longer than about 5 mm, typically no longer than about 1 mm, are typically referred to as “microfibres”.

The feed preferably comprises less than 30 wt %, more preferably less than 20 wt % and especially less than 10 wt % of solid material prior to entry into the filter (as a percentage of the total mass of the solid material and the liquid).

The feed preferably comprises at least 0.001 wt %, more preferably at least 0.01 wt % and especially at least 0.1 wt % of solid material (as a percentage of the total mass of the solid material and the liquid).

Preferably, the feed comprises from about 0.01 wt % to about 5 wt % solid material, more preferably from about 0.1 wt % to about 3.5 wt % solid material (as a percentage of the total mass of the solid material and the liquid).

First end, Second end and one or more side walls

The first end, second end and the one or more side walls of the filter may each independently be or comprise a thermoplastic, a thermoset, a metal, an alloy or a ceramic material.

The inlet located in the first end of the filter may be located along the axis of rotation. Alternatively, or in addition the inlet in the first end may be located in the first end of the filter further out from the axis of rotation, for example towards where the side walls meet the first end.

The second end preferably has a surface which readily engages with a drive means of a filter unit.

Preferably, the first end, second end and side walls create a filter shape which is readily rotatable about an axis of rotation without causing any substantial imbalance or vibration when rotated. Preferred shapes for the filter have a rotational symmetry when viewed from the first end and looking towards the second end. Preferred shapes for the filter are or approximate to cylindrical shape. Cylindrical shapes are most preferred although prisms based on higher order polygons with or without smoothed edges are good and perfectly suitable approximations to a cylinder. Higher order polygons include those with 5 or more sides such as 6, 7, 8, 9 and 10 sides.

Preferably, the one or more side walls are attached to the first end; and the second end is detachable from the one or more side walls. Suitable ways to implement said detachability include clips, bolts, screws, magnets, screw threads, interference surfaces and the like. Where the second end is detachable from the one or more side walls it is preferred that a seal is provided. Examples of suitable seals include O-rings, gaskets and the like.

The present inventor has found this “detachability” to be especially helpful to easily disassemble the filter and to access and clean out solid material which has accumulated on the interior surface of the one or more side walls.

Even more preferably, the filter is configured such that the first end and the side walls can be detached from the filter leaving behind the second end and the filter medium. In this way the first end and side walls can be removed without disturbing the filter medium.

Filter Media in the First End and/or Second End

Preferably, the filter has a filter medium located in the first and/or second end of the filter. Such filter media may perform filtering of the feed, but may also assist in dewatering of the accumulated solid material just prior to removal of the filter from the filter unit and prior to removing the accumulated solid material from the filter. Preferably, where such a filter medium is present in the first and/or second end then dewatering of the accumulated solid material can be achieved by rotating the filter, especially rotating the filter so as to cause liquid to be spun out of the accumulated solid material.

Impeller

The filter optionally comprises an impeller. Where the filter comprises an impeller, the impeller rotates during operation of the filter along with the filter itself. The rotation of the impeller is helpful in urging the feed liquid through the filter. In the case where the impeller is present the filter can function both as a filter and as a liquid pump. The impeller may take the form of a plurality of blades extending radially outwards from the axis of rotation. A typical impeller has 2 to 10 impeller blades, preferably 2, 3, 4, 5, 6, 7 or 8 blades which are more preferably equally spaced in the filter chamber.

The impeller can be in the form of an impeller layer within the filter. A plurality of impellers can be present in the filter and these can be in the form of impeller layers.

Preferably, the impeller layer is substantially disc-shaped with or without cut-out portion towards the circumference of the disc.

Directing Layer

The filter can comprise a directing layer which assists in directing the liquid flow having passed through the filter media, towards a common portion of the flow path.

Preferably, the directing layer is in the form of a disc with or without cut-out portions towards the circumference.

Combinations of Layers

When the filter comprises a plurality of filter media, at least some of which are stacked in layers, as set out for requirement iv., it is preferable to additionally have one or more directing layers and optionally one or more impeller layers which are preferably also stacked.

Preferably, the filter comprises a directing layer, a filter layer and an optional impeller layer. Preferably, the layers are stacked with the directing layer, optional impeller layer and filter layer in that order or in the reverse order running from closest to the first end to furthest away from the first end.

A more preferred sequence is filter layer, optional impeller layer, directing layer, optional impeller layer, filter layer. In this sequence one directing layer is associated with two filter layers and optionally two impeller layers.

When the filter comprises layers, each of the filter layer, the directing layer and the optional impeller layer preferably have apertures which can be aligned. Preferably the apertures are located around the circumference of each layer, proximate to the side wall. These aligned apertures preferably form the common portion of the flow path.

The layers preferably are also disc-shaped.

Each of the layers preferably has cut-out portions towards the circumference which are aligned with each other. By way of this alignment the cut-out portions provide regions where during operation of said filter, solid material present in the feed can accumulate on an interior surface of the one or more side walls.

The layers preferably also have openings through which one or more guides can be inserted. These guides serve to lock-down and align the layers. In this manner the abovementioned apertures which form the common portion of the flow path are suitably fixed in place during the operation and rotation of the filter when in use.

The layers are preferably terminated by a top layer which is located closest to the first end.

Each layer preferably has an axial aperture which permits feed to flow towards the filter medium or media. This axial aperture in the layers preferably is aligned with the inlet in the first end.

Accumulation Regions

Preferably, the filter comprises one or more regions where during operation of said filter, solid material present in the feed can accumulate on an interior surface of the one or more side walls.

The filter may comprise a single region around to the interior surface of the side wall(s), especially when the side wall is cylindrical.

The filter may comprise multiple regions around the interior surface of the side wall(s). These regions can be separate from each other.

Each region is preferably located radially outwards from the filter medium.

When the filter comprises more than one filter medium it is possible to have each region associated with one or more filter media.

Optionally, the filter can comprise a plurality of regions and each region can be separately opened or detached from the filter. In this way the present inventor has found that access to and removal of solid material accumulated in the filter can be easily achieved.

When the filter comprises a plurality of stacked layers as described in requirement iv. of the first aspect of the present invention, each of the layers preferably has one or more cut-out portions towards the circumference which are aligned. By way of this alignment the cut-out portions provide regions where during operation of said filter, solid material present in the feed can accumulate on an interior surface of the one or more side walls. The accumulation of solid material in regions around the interior surface of the side wall avoids blocking the flow of the feed as it passes through the filter.

Outlet

The filter preferably comprises one or more outlets by which the filtered feed exits the filter. Where requirement iii. is mandatory the flow path preferably terminates with a flow path outlet in the filter. Preferably, other than filtered feed there is no other kind of liquid stream which exits the filter or the filter unit.

The outlet in the filter may be in the form of one or more filter media located in for example the first and/or second end. As mentioned above these are especially suitable for dewatering the solid material. Less preferably the outlet may derive from the perforations which are optionally present in the side wall.

In any case, the outlet is preferably located in the first end and/or in the second end. Typically, the outlet is towards the periphery of the first end or second end and further away from the axis of rotation.

Filter Cartridge

The filter according to the first aspect of the present invention is preferably in the form of a filter cartridge. Preferably, the cartridge can be readily inserted into a filter unit and attached to a drive means within the filter unit.

Requirement i)

Preferably, at least a portion of said first surface of the filter medium is oriented such that when the filter is operating and rotating about the axis of rotation any solid material accumulating on said first surface is urged away from the first surface.

Preferably, any solid material accumulating on said first surface is urged in a direction which is radially outwards from the axis of rotation of the filter. Preferably, the solid material is urged towards the side wall or side walls. Solid material accumulating at the first surface may be urged so as to slide along the surface of the filter medium provided that it is eventually urged away from the first surface.

Unless stated to the contrary the words “first surface” take the meaning of the surface through which the feed enters the filter medium and is filtered. It will be appreciated that in prior art filters this is the surface of the filter on which solid material would tend to accumulate.

The present inventor discovered that when a portion of the first surface is oriented as described in requirement i. of the first aspect of the present invention the filter medium is less prone to blinding or to the accumulation of solid material on said first surface. During the operation of such a filter it is theorised that the rotation of the filter about the axis of rotation causes or imparts a centripetal force on filter material residing on the first surface which in turn urges and moves the solid material away from the first surface. In this way the filter has an ability to “self-clean” the filter medium when in operation.

The orientation of the first surface can be in a plane which is parallel to or angled with respect to the radial plane. In order of increasing preference at least a portion of said first surface is preferably oriented in a plane which is no more than 50 degrees, no more than 40 degrees, no more than 30 degrees, no more than 20 degrees, no more than 10 degrees, no more than 5 degrees, no more than 3 degrees, no more than 2 degrees from a radial plane when the filter is in operation. In FIG. 1 this angle is labelled α.

The radial plane is preferably defined as a plane which is perpendicular to the axis of rotation when the filter is in operation and is being rotated around the axis of rotation.

Alternatively, at least a portion of said first surface may be oriented such that it faces at least one of the side walls. In such cases at least a portion of the first surface can be oriented parallel to the axis of rotation or it can be oriented somewhat angled with respect to the axis of rotation. In order of increasing preference the angle is preferably no more than 40 degrees, no less than 30 degree, no more than 20 degrees, no more than 10 degrees no more than 5 degrees, no more than 3 degrees, no more than 2 degrees from being parallel to the axis of rotation. In FIG. 3 this angle is labelled β.

In order of increasing preference, the portion of said first surface as described in requirement i. is at least 5%, at least 10%, at least 20%, at least 30%, at least 40%, at least 50%, at least 60%, at least 70%, at least 80%, at least 90%, at least 95% or all (i.e. 100%) of the surface area of said first surface. The percentages are based on the area and thus by way of example a filter medium having a first surface with a total area of 10 cm² and a portion oriented as described above of an area of 5 cm² equates to 50%.

Preferably, during operation of the filter the feed flows over said first surface in a direction flowing away from the axis of rotation and towards the side wall or walls.

Preferably, the first surface of the filter medium is not coincident with or shared with any of the one or more side walls.

The feed, as it passes through the filter medium, preferably does so in a direction which is not radially outwards as it passes through the filter medium.

The feed may pass through the filter medium in a direction which is parallel to the axis of rotation or which is offset from the axis of rotation by an angle. In order of increasing preference, the offset angle is no more than 50 degrees no more than 40 degrees, no more than 30 degrees, no more than 20 degrees, no more than 10 degrees, no more than 5 degrees and no more than 2 degrees.

The feed may pass through the filter medium in a direction which is radially inwards. This feed direction is especially suited to a first surface which faces at least one of the side walls.

That is to say that that the feed may pass through the filter medium in a direction from further away from the axis of rotation to nearer the axis of rotation. This direction can be angled with respect to the axis of rotation and in order of increasing preference is preferably no more than 40 degrees, no more than 30 degree, no more than 20 degrees, no more than 10 degrees no more than 5 degrees, no more than 3 degrees, no more than 2 degrees from being parallel to the axis of rotation.

Requirement ii)

Preferably, at least one of the side walls of the filter may have perforations provided that no more than 50% of the surface area of said at least one side wall is occupied by said perforations;

In order of increasing preference at least one of the side walls of the filter may have perforations provided that no more than 40%, no more than 30%, no more than 20%, no more than 10%, no more than 5%, no more than 3%, no more than 2%, no more than 1% and no more than 0.5% of the surface area of said at least one side wall is occupied by said perforations. By way of example a side wall having a total area of 10 cm² and perforations which total 2 cm² equates to 20%.

In order of increasing preference, when the filter has two or more side walls, then two or more of the side walls of the filter may have perforations provided that in totality no more than 40%, no more than 30%, no more than 20%, no more than 10%, no more than 5%, no more than 5%, no more than 3%, no more than 2%, no more than 1% of the total surface area of all of the side walls are occupied by said perforations.

More preferably at least one of the side walls has no perforations. Even more preferably no side wall present in the filter has perforations.

The present inventor determined that side walls as described above provide a particularly suitable and effective surface on which solid material can accumulate during operation of the filter. In particular, the present inventor found that a lower level of porosity of the side walls provides for easier cleaning of the filter when the accumulated solid material needs to be removed from the filter. It was also found that using pores in the side walls of the filter results in an increased propensity for the pores to become blinded and/or for flow rates to reduce when the filter has operated over many cycles or has filtered larger total volumes of feed.

Preferably, the one or more side walls are attached to the first end; and the second end is detachable from the one or more side walls. This “detachability” enables easy disassembly of the filter and allows access and cleaning of solid material which has accumulated on the interior surface of the one or more side walls.

Even more preferably, the filter is configured such that the first end and the side walls can be detached from the filter leaving behind the second end and the filter medium. In this way the first end and side walls can be removed without disturbing the filter medium.

Preferably, the filter comprises one or more regions where during operation of said filter, solid material present in the feed can accumulate on an interior surface of the one or more side walls.

Requirement iii)

Preferably, the filter additionally comprises a flow path which is defined and constrained by one or more surfaces within the filter chamber, said flow path having at least a portion which is not coincident with the axis of rotation of the filter during operation nor is it radial with regard to the axis of rotation during operation.

Preferably, at least a portion of the flow path is defined and constrained by one or more surfaces in the form of channels, tubes, pipes and the like.

Preferably, the flow path terminates with a flow path outlet in the filter.

Preferably, the flow path outlet in the filter is located in the second end of the filter.

Preferably, the flow path is not defined and constrained by one or more surfaces which include the interior surface of any of the side walls.

Preferably, the flow path is separated from the one or more side walls and from the axis of rotation of the filter.

Preferably, the filter has a flow path which is configured such that when in operation, filtered feed flowing along the flow path will not disturb solid material which has accumulated on the interior surface of the one or more side walls.

The present inventor has found that one advantage of the use of these flow paths is that it reduces the tendency to disturb solid material which has accumulated on the interior surface of the one or more side walls. A second advantage is that filtered feed can exit the filter easily and thereby provide good flow rates.

Preferably, the filter comprises a plurality of filter media.

Preferably, the filter comprises a plurality of flow paths as defined in requirement iii. of the first aspect of the present invention.

Preferably, the filter comprises a plurality of filter media, and a plurality of flow paths, more preferably each flow path is associated with a filter media.

Preferably, each flow path begins proximate to an associated filter media, more preferably the flow path begins proximate to the point where the feed has just passed through the associated filter medium. Preferably the flow paths do not include passage through a filter medium.

Preferably, at least a portion of the flow paths is common and more preferably ends in a shared flow path outlet in the filter.

Common portions of the flow paths preferably run from the nearer to the first end and towards the second end with regard to the flow of the filtered feed when the filter is in operation. The common portions of the flow path may be parallel to the axis of rotation or they may be angled with respect to the axis of rotation. In order of increasing preference the angle is preferably no more than 60 degrees, no more than 30 degrees, no more than 20 degrees, no more than 10 degrees no more than 5 degrees, no more than 3 degrees, no more than 2 degrees from being parallel to the axis of rotation. Common portions of the flow path are preferably not near to the central axis. The common portions of the flow path are preferably at least 30%, at least 40%, at least 50%, at least 60%, at least 70% and at least 80% out towards the one or more side walls from the axis of rotation. Thus, a cylindrical filter of radius 10 cm wherein the common portions run parallel to the axis of rotation but 8 cm from the axis of rotation and 2 cm from the side walls equates to being 80% out towards the cylindrical side wall.

The filter may have any number of common portions of the flow paths although 2, 3, 4, 5, 6, 7, 8, 9 and 10 common portions are easily suitable.

Preferably, the filter has a plurality of flow path outlets. Preferably, there is one flow path outlet for each flow path common portion.

Requirement iv)

Preferably, the filter comprises a plurality of filter media, at least some of which are stacked in layers.

Preferably, wherein the filter media in the stacked layers are all of the same shape, with the shapes being selected from those having a planar, corrugated, concave and convex shape.

Preferably, the filter media in the stacked layers all have a planar shape.

The number of filter media stacked in layers is preferably at least 2, at least 3, at least 4, at least 5 and at least 6 layers. Any number of filter media may be stacked although no more than 1000, more preferably no more than 100 and especially no more than 50 are stacked.

The layers are preferably stacked such that each layer is substantially parallel to a radial plane. The layers are preferably substantially parallel to the first end and second end.

Preferably, all of the layers are in a plane which is substantially parallel.

By substantially parallel here it is preferably meant that the angle from being parallel is 20° or less, more preferably 10° or less and need not be exactly or precisely parallel.

When the filter has a cylindrical shape the layers are preferably in the form of discs, optionally with one or more cut-out portions towards the circumference of the disc. Preferably, the discs are stacked substantially parallel to the first end and second end and substantially parallel to the radial planes.

The discs are preferably stacked such that their centres are aligned with the axis of rotation.

Preferably, each and every filter medium is in fluid communication with the feed.

Preferably, each layer has an aperture located proximate the axis of rotation which can be aligned with the inlet located in the first end of the filter.

At least a portion of the plurality of stacked filter media may be arranged to filter feed from the inlet in parallel, and not in series. At least a portion of the plurality of filter media may be arranged to each receive unfiltered feed from the inlet in parallel. In this way, the feed passes through the inlet, into the filter chamber and through one of the filter media.

At least a portion of the plurality of filter media may comprise the same pore sizes. At least a portion of the plurality of filter media may comprise the same filter material.

The present inventor has found that when the filter comprises a plurality of filter media which are stacked in layers it is possible to substantially improve the flow rates for a given filter size. Additionally, by having such stacked filter media it is possible to simultaneously meet other requirements of the present invention in a synergistic way.

Combined Requirements i) to iv)

Whilst the present invention works very well with any one of requirements i) to iv) it has been found that combinations of these requirements work synergistically. Any of requirements i), ii), iii) and iv) can be combined with any of the other requirements singularly or in combination.

Preferred combinations of requirements include: i)+ii); i)+iii); and i)+iv); ii)+iii); or ii)+iv); and iii)+iv). Further preferred combinations include: i)+ii)+iii); i)+iii)+iv); and i)+ii)+iv). One preferred combination is requirements i), ii) and iii).

The most preferred combination is all of the requirements i) to iv). In such a combination the requirements work extremely effectively together in a cooperative manner.

### First Embodiment

In a first embodiment the filter is preferably substantially cylindrical in shape, thus the first end and second end are substantially circular, and the filter has a single cylindrical side wall.

Preferably, the filter has a plurality of filter media, the first surface of the filter media are preferably oriented such that when the filter is operating and rotating about the axis of rotation any solid material accumulating on said first surface is urged away from the first surface of the filter media. The filter media are preferably planar and the first surface is preferably oriented substantially parallel to a radial plane. The filter media are preferably located in the first end and the second end, and preferably are equally spaced apart. Preferably the filter media are located further away from the axis of rotation and more towards the outmost circumference of the first end and second end. The filter media additional serve as the outlets for this filter. The filter comprises an inlet located in the first end which is located axially and which allows feed to enter the filter chamber when in use. The filter comprises an impeller in the form of several flat blades projecting outwardly from the axis of rotation. The cylindrical side wall preferably has no perforations whatsoever. The filter comprises no flow paths as defined in requirement iii. of the first aspect of the present invention. The filter has no filter media stacked in layers. The first end is preferably detachable from the side wall and the second end. The second end preferably has a surface which readily engages with the drive means of the filter unit. This filter has been found to be particularly elegant and can be constructed particularly cost effectively. In this embodiment feed entering the filter media passes through the filter media and then immediately exits the filter chamber through the first and second ends.

### Second Embodiment

In a second embodiment the filter is preferably substantially cylindrical in shape, thus the first end and second end are substantially circular, and the filter has a single cylindrical side wall.

The filter comprises an inlet located in the first end which is located axially and which allows feed to enter the filter chamber when in use.

Preferably, the filter has a plurality of filter media, the first surface of the filter media are preferably oriented such that when the filter is operating and rotating about the axis of rotation any solid material accumulating on said first surface is urged away from the first surface. The filter media are preferably planar and the first surface is oriented substantially parallel to a radial plane. A number of filter media are preferably located on a filter support which combined with the filter media are in the form of a layer in a disc shape. This is the filter layer. The filter layer has cut-out portions towards the circumference of the disc. The filter preferably comprises a plurality of such disc-shaped layers. The filter layers are preferably stacked together with other layers as described below.

The filter preferably also comprises directing layers which serve to direct the liquid flow after passing through the filter media towards a common portion of the flow path. These directing layers are in the form of a disc with cut-out portions towards the circumference.

The filter preferably also comprises impeller layers in the form of a substantially disc-shape with cut-out portions towards the circumference. Each impeller layer preferably comprises from 2 to 10 impeller blades.

The filter preferably comprises a top layer which terminates the layers closest to the first end.

Each of the layers present in the filter have an axial aperture to permit feed entering the filter to pass towards the filter layers.

The layers are preferably present in the filter in a stacked fashion.

Each of the layers present has cut-out portions towards the circumference which are aligned. By way of this alignment the cut-out portions provide regions where during operation of said filter, solid material present in the feed can accumulate on an interior surface of the one or more side walls.

The cylindrical side wall preferably has no perforations whatsoever.

Preferably, the filter layers; and more preferably the filter layers, the directing layers and the optional impeller layers all have apertures around their circumference, proximate to the side wall. These apertures are preferably aligned when the layers are stacked in the filter so as to provide one or more common portions of the flow path. Preferably the filter comprises one or more flow path outlets located in the second end.

The present inventor has found that this embodiment provides especially good flow rates and an especially good resistance to becoming blocked. Thus, this embodiment provides a filter which is capable of filtering many treatment cycles or a large total volume of feed.

### Third Embodiment

In a third embodiment the filter is preferably substantially cylindrical in shape, thus the first end and second end are substantially circular, and the filter has a single cylindrical side wall.

The filter comprises an inlet located in the first end which is located axially and which allows feed to enter the filter chamber when in use. Preferably, the first surface of the filter media is oriented such that when the filter is operating and rotating about the axis of rotation any solid material accumulating on said first surface is urged away from the first surface. In this way the filter is “self-cleaning” during operation and rotation.

The first surface of the filter medium is preferably oriented such that it faces the side wall. The first surface of the filter medium is preferably oriented substantially parallel to the axis of rotation. The filter medium may take the form of a curved or cylindrical surface. The filter medium preferably surrounds the axis of rotation. Several filter media can be used to surround the axis of rotation.

Preferably, the side wall has no perforations.

The filter preferably has no filter media which are stacked.

Filter Unit

According to a second aspect of the present invention there is provided a filter unit comprising a filter according to the first aspect of the present invention. It will be appreciated that the filter unit described herein is a centrifugal filter unit.

Preferably, the filter unit comprises a filter unit housing, a drive means for rotating the filter around an axis of rotation, a housing inlet which during use allows feed to enter the filter unit and a housing outlet which during use allows feed to exit the filter unit.

The drive means preferably is or comprises a motor and especially an electric motor.

When present, the impeller may also be rotated by the drive means. Preferably, the impeller is coupled to the filter such that the impeller rotates at the same speed as the filter. In this way, the impeller does not directly engage the drive means but is caused to rotate when the filter is rotated by the drive means.

The filter unit may comprise a controller for controlling the rotation of the drive means. Preferably, the controller is operated or programmed to cause the drive means to rotate the filter at a first speed for filtering solid material from the feed and at a second speed for dewatering the filtered solid material. Typically, the second speed for dewatering the filtered solid material is higher than the first speed for filtering solid material from the feed. Operating the filter unit such that the filter rotates at the second speed increases the centrifugal force and enables improved removal of liquid from the filtered solid material contained within the filter. Dewatering in this way compresses the solid material, for example forming a “filter cake”, which improves the ease of removal of the solid material from the filter chamber. Compressed solid material is easier and more hygienic to handle and can be disposed of with normal waste. Compressing the solid material in this way advantageously increases the interval between needing to empty or clean the filter chamber. Dewatering also beneficially conserves liquid in the apparatus in which the centrifugal filter unit is used.

The rotation speed of the filter in the filter unit during filtration of the feed may be selected depending on various factors, for example, the diameter of the filter, the type of filter medium being used and/or the concentration of solid material in the feed.

The filter unit may be or comprise a thermoplastic, a thermoset, a metal, an alloy or a ceramic material.

The filter unit can be water-tight. Preferably, by water-tight it is meant that no feed exits the filter unit other than via the filter unit outlet. Thus, there are no gaps, apertures or the like where feed could leak. A water-tight filter unit is especially suited to operation in a substantially horizontal orientation, that is to say that the axis of rotation of the filter is aligned substantially horizontally. Additionally, a water-tight filter unit can be situated beneath the water level of any treatment apparatus (e.g. a washing machine). Thus, by way of example a water-tight filter unit can be located below the drum and/or below the sump in a washing machine. A further advantage of a water-tight filter unit is that feed can be forced through the filter unit at a pressure of greater than 1 atmosphere. Another advantage of a water-tight filter unit is that the contents of the filter can be kept moist until the filter requires cleaning, for example to remove excess accumulated solid material. The present inventor has found that allowing the contents of the filter unit to dry, especially allowing the filter medium or media to dry, can cause the filter medium or media to become prematurely blocked.

The filter unit can be open to the environment.

The filter unit may not be water-tight.

The filter unit may have one or more openings in the filter unit housing other than the housing inlet and outlet. When this is the case the one or more openings are preferably in the first end.

Filter units which are open to the environment or not water-tight are preferably configured to operate in a substantially vertical orientation. “In a substantially vertical orientation” is meant that the first end of the filter is arranged substantially vertically above the second end of the filter and the axis of rotation is aligned substantially vertically.

Treatment Apparatus

According to a third aspect of the present invention there is provided a treatment apparatus, for treating a substrate with a treatment formulation comprising a liquid, the treatment apparatus comprising a drum for rotating the substrate and the treatment formulation, a drive means for rotating the drum and a filter according to the first aspect of the present invention or a filter unit according to the second aspect of the present invention.

Preferably, the treatment apparatus is a washing machine, a textile treatment machine or a tanning machine.

Suitable textile treatment machines include those adapted for colouring (e.g. dyeing), stonewashing, abrading and applying surface treatments.

The drum of the treatment apparatus may have a capacity permitting no more than 15 Kg of dry substrate to be treated at any given time.

The drum of the treatment apparatus may have a capacity permitting more than 15 Kg of dry substrate to be treated at any given time.

The drum of the treatment apparatus may have a capacity of no more than 120 litres. Such drum sizes are especially suitable for use in domestic apparatus for example domestic washing machines. The drum preferably has a capacity of at least 1 litre and more preferably at least 10 litres.

The drum of the treatment apparatus may have a capacity of more than 120 litres, for example it may have a capacity which is more than 200 litres, more than 400 litres, more than 900 litres or more than 1400 litres. Drums of such larger dimensions are especially suitable for commercial or industrial applications. The drum may have any upper limit to its capacity, preferably the drum has a capacity of no more than 20,000 litres or no more than 10,000 litres.

The drive means for rotating the drum is preferably a motor and especially an electric motor.

The liquid is preferably aqueous. Preferably the liquid in the treatment formulation is as described for the feed liquid.

The liquid may comprise one or more treatment additives selected from dyes, pigments, surfactants, enzymes, acids, bases, buffering agents, oxidizing agents, builders, biocides, anti-staining agents, tanning agents.

The treatment apparatus is preferably electrically connected to the filter unit according to the second aspect of the present invention.

The treatment apparatus may comprise a controller unit which is preferably connected to the filter unit according to the second aspect of the present invention.

The controller in the treatment apparatus may directly control the drive means in the filter unit. Thus, the controller in the treatment apparatus may comprise memory loaded with a programme which when operated by a processor controls the drive means in the filter unit. In this way the filter unit is under the direct control of the treatment apparatus.

Alternatively, the filter unit may comprise a controller. The controller in the filter unit may sense or be sent information relating to the actions of the controller in the treatment apparatus and the controller in the filter unit has memory loaded with a programme which when operated by a processor controls the drive means in the filter unit. In this way the filter unit is not under the direct control of the treatment apparatus but instead it “has a knowledge” of what the treatment apparatus is doing and can respond accordingly. As an example, the controller in the filter unit may sense that the waste valve in the treatment apparatus has been opened and/or that a waste pump has been activated and it may then respond by powering the drive means of the filter unit so as to begin filtration with the filter unit.

Preferably the apparatus comprises: a tub in which a drum is rotatably mounted, said drum having side walls and said side walls comprising one or more apertures configured to permit said treatment formulation to exit the drum; an access means moveable between an open position wherein the at least one substrate can be placed in the drum and a closed position wherein the apparatus is substantially sealed; a collector, wherein said collector is located beneath said drum and is configured to collect said treatment formulation that exits the drum; a filter or filter unit as disclosed herein; and a first flow pathway between the collector and the inlet of the filter or filter unit.

The outlet of the filter or filter unit may be fluidly connected to the drum. In this way, liquid that has passed through the filter may be returned to the drum. Alternatively, the outlet of the filter or filter unit may be fluidly connected to a drain. Preferably, the apparatus further comprises a control valve configured such that filtrate that exits the outlet of the filter is selectively recirculated to the drum or sent to a drain.

The apparatus may further comprise a recirculation means for recirculating said treatment formulation from said collector to said drum, wherein the filter or filter unit is comprised in the recirculation means. In this way, the filter filters treatment formulation during its recirculation from the collector to the drum. Typically, the recirculation means comprises a pump and ducting which connects the collector and the drum.

The apparatus may comprise a second filter element positioned such that treatment formulation passes through the second filter element prior to entering the inlet of the filter or filter unit. The second filter element may be a coarse filter to prevent large pieces or items of solid material from entering the filter, for example, coins or other items from pockets when washing laundry.

The apparatus may be configured such that the treating of the substrate with the treatment formulation is able to occur in the presence of solid particulate material. For example, the apparatus may be configured such that the solid particulate material is able to exit the drum through the apertures and is collected in the collector. When configured in this way, preferably the apparatus comprises a recirculation means for recirculating the solid particulate material and said treatment formulation from the collector to the drum.

Typically the recirculation means comprises a pipe or duct between the collector and the drum, the pipe or duct may be described as a “flow pathway pipe”.

Preferably, the recirculation means comprises a first pump. The first pump assists in transferring solid particulate material that exits the outlet of the collector back to the drum. For the first pump to operate properly, at least a portion of the treatment formulation in the collector also exits the collector with said solid particulate material and enters the recirculation means, and is thereby recirculated to the drum. Preferably, the recirculation means comprises a separator. The recirculation means separator functions to separate solid particulate material from the treatment formulation that has been recirculated from the collector so that substantially only solid particulate material re-enters the drum. Preferably, the recirculation means separator is mounted in the access means of the apparatus. Alternatively, the recirculation means separator is preferably mounted above the access means.

Treatment formulation that is separated by the recirculation means separator is preferably directed back to the collector. The treatment formulation may be returned to the collector via a drain in the access means. Alternatively, the treatment formulation may be returned to the collector via a pipe, wherein the pipe does not pass through the access means.

Where the apparatus comprises recirculation means for recirculating solid particulate material, the filter or filter unit is preferably positioned in the recirculation means between the separator and the collector, such that treatment formulation that is separated by the recirculation means separator enters the filter via the inlet of the filter. Filtered treatment formulation that exits the outlet of the filter is directed to the collector. In this way, at least a portion of residual solid material that has passed through the recirculation means separator can be removed from the treatment formulation by the filter. Preferably, substantially all residual solid material in the treatment formulation is removed by the filter. Repeated recirculation of treatment formulation through the filter can result in “polishing” of the treatment formulation.

Alternatively, where the apparatus comprises recirculation means for recirculating solid particulate material, the filter may be positioned between the collector and a drain. In this way, at least a portion of residual solid material in the treatment formulation is removed before disposal of the treatment formulation. Thus, reducing the amount of solid material entering the drain.

In an alternative arrangement of the apparatus, in which the apparatus is configured such that the treating of the substrate with the treatment formulation is able to occur in the presence of solid particulate material, solid particulate material is unable to exit the drum through the apertures. Where the solid particulate material is unable to exit the drum through the apertures, the apparatus preferably comprises an in-drum storage for the solid particulate material.

Where the treating of the substrate includes treating with solid particulate material, the solid particulate material preferably comprises a multiplicity of particles. The particles of the solid particulate material may be polymeric and/or non-polymeric particles.

Method

According to a fourth aspect of the present invention there is provided a method of filtering a feed comprising solid material in the form of particles and a liquid using a filter according to the first aspect of the present invention or a filter unit according to the second aspect of the present invention and rotating the filter whilst the feed flows through the filter.

The method of the fourth aspect is especially suitable for filtering solid material as mentioned above.

Preferably, the particles are or comprise fibres.

In particular, the method of the fourth aspect of the present invention is especially suited to filtering particles which are or comprise fibres and at least some of said fibres have a longest linear dimension of from 1 μm to 1 mm. The present inventor has found the filter, filter unit, treatment apparatus and method are especially suited to filtering and at least partially removing fibres of this size.

The solid material being filtered in the method of the fourth aspect of the present invention typically includes fibres or particles derived from the substrate (also known as “lint”), soil or a combination thereof. As used herein, the “substrate” may be or comprise a textile and/or an animal skin substrate. In a preferred embodiment, the substrate is or comprises a textile. The textile can be or comprise a synthetic fibre, a natural fibre or a combination thereof. The textile can comprise a natural fibre which has undergone one or more chemical modifications.

Preferably, the textile has been treated in a treatment formulation comprising liquid.

The treatments preferably include washing, colouring (especially dyeing and pigmenting), abrading, ageing, softening, bleaching, sterilising, desizing and depilling, tanning and combinations thereof.

The method is especially suited to filtering feeds which originate from a treatment or from a treatment apparatus as previously mentioned.

Preferably, the treatment apparatus is used to rotate (especially tumble) one or more substrates (especially one or more substrates which are or comprise a textile) and a liquid in a drum.

Preferably, at least some of the fibres in the feed are or comprise a synthetic. Examples of synthetic fibres include nylon, polyester, polyurethane, acrylic, acrylonitrile and the like.

The present inventor found that the filter, filter unit, treatment apparatus and methods of the present invention help to prevent the release of synthetic fibres from the apparatus in which the substrate is being treated out into the waterways and the environment. Preferably, substantially all synthetic fibres from the substrate are prevented from being released from the apparatus. Reducing the amount of synthetic fibres derived from the substrate that are released from the apparatus can have a substantial environmental benefit.

The feed may be at a temperature of from 5 to 95° C., more preferably from 5 to 70° C. and especially from 10 to 60° C. as it passes through the filter.

Typically, the filter is primed with liquid, more preferably with an aqueous liquid and especially with water prior to the feed entering the filter.

Typically, the filter or filter unit is rotated and brought up to the desired speed prior to feed entering the filter.

In a preferred method the filter or filter unit is preferably rotated at a first speed for filtering solid material from the feed and at a second (and preferably higher) speed for dewatering the filtered solid material.

Many feeds originating from many treatments may be filtered by rotating the filter at the first speed. The second higher speed is typically used when the filter or filter unit has accumulated a significant amount of solid material and requires or would benefit from being cleaned.

In order of increasing preference, the filter according to the first aspect of the present invention or the filter unit according to the second aspect of the present invention is able to filter feeds from at least 2, 3, 4, 5, 10, 20, 30, 50 and 100 treatments prior to becoming blocked or requiring cleaning.

In order of increasing preference, the filter according to the first aspect of the present invention or the filter unit according to the second aspect of the present invention is able to filter feeds whose total volume is at least 10, 50, 100, 500, 1000, 5000 and 10000 litres prior to becoming blocked or requiring cleaning. The total volume which the filter can tolerate before it becomes blocked or requires cleaning may be referred to as the “total duty volume”.

The filter or filter unit may be operated such that the feed flows through the filter once (and only once). This method or operation is relatively fast.

The filter or filter unit may be operated such that the feed is cycled through the filter several times. This method of operation can provide especially good efficiencies of filtration although the filtering times required may be a little longer. Preferably, the feed is cycled through the filter at least 2, 3, 4 and 5 times. Preferably, the feed is cycled through the filter no more than 100 times.

Use

Preferably, according to a fifth aspect of the present invention there is provided the use of a filter according to the first aspect or a filter unit according to the second aspect of the present invention for filtering a feed.

The feed and the way in which the filtering is performed is preferably as described above.

### FIGURES

The invention is further illustrated with reference to the following figures in which:

FIG. 1 shows a schematic representation of the orientation of the first surface of the filter medium in part of a cross-section of a filter where the first surface of the filter medium is oriented in a plane at an angle α to the radial plane.

FIG. 2 shows a schematic representation of an alternative orientation of the first surface of the filter medium in part of a cross-section of a filter where the first surface of the filter medium is oriented in a plane which is parallel to the radial plane.

FIG. 3 shows a schematic representation of an alternative orientation of the first surface of the filter medium in part of a cross-section of a filter where the first surface of the filter medium is parallel to the axis of rotation and faces the side wall of the filter.

FIG. 4 shows a 3D cross-section view of a filter according to the present invention.

FIG. 5 shows an exploded isometric view on an alternative filter with many of the layers of the filter separated and partially disassembled.

FIG. 6 is an illustration of a cross-section of an alternative filter according to the present invention.

### DETAILED DESCRIPTION

The present invention will now be further elaborated by reference to the figures which are non-limiting.

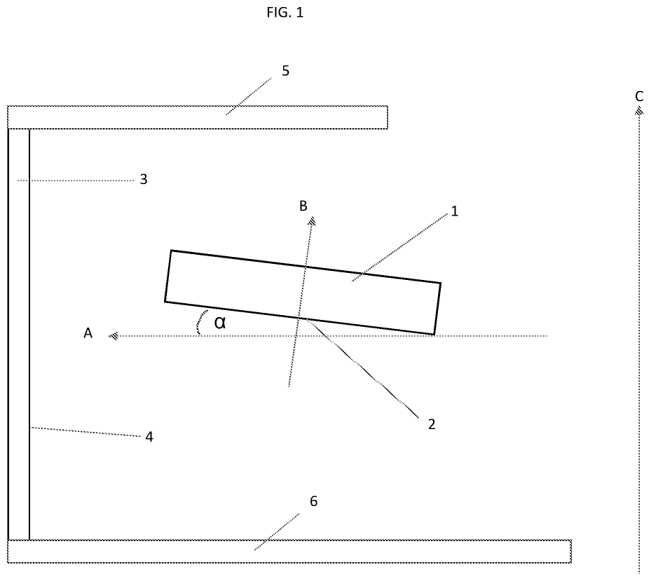

FIG. 1 shows a schematic representation of the orientation of the first surface of the filter medium in part of a cross-section of a filter where the first surface is oriented in a plane at an angle α to the radial plane.

FIG. 1 shows the filter medium (1), the first surface (2) of the filter medium and radial plane labelled (A) which points away from the axis of rotation (C). The radial plane (A) is the plane which is perpendicular to the axis of rotation (C) when the filter is in operation and is being rotated around the axis of rotation. The first end (5) and the second end (6) are shown in part. The first surface (2) of the filter medium is oriented in a plane which has an angle α with respect to the radial plane when the filter is in operation. The arrow labelled (B) shows the direction of the flow of the feed as it passes through the filter medium (1). The side wall (3) has an interior surface (4) on which solid material will accumulate during the operation of the filter. When the filter is operating and rotating about the axis of rotation (C) any solid material accumulating on the first surface (2) is centripetally urged away from the first surface (2) of the filter medium. Thus, a filter as shown in FIG. 1) will tend to self-clean the first surface (2) and the solid material will instead tend to accumulate on the interior surface (4) of the side wall (3).

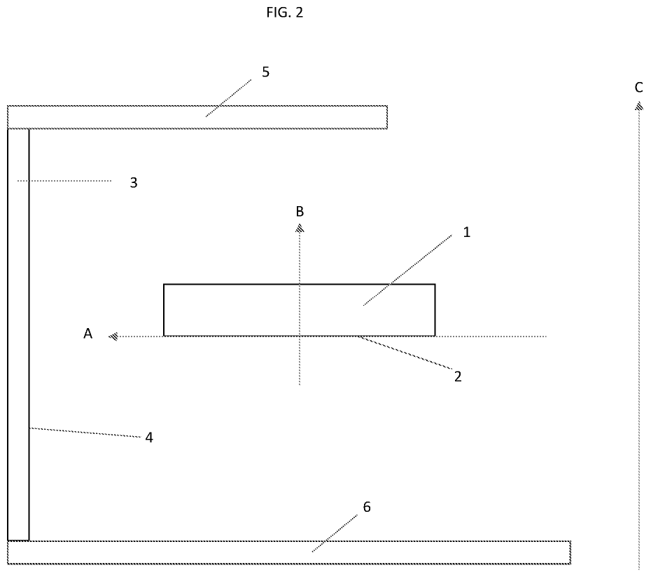

FIG. 2 shows a schematic representation of the orientation of the first surface of the filter medium in part of a cross-section of a filter where the first surface of the filter medium is oriented in a plane parallel to the radial plane.

FIG. 2 shows the filter medium (1), the first surface (2) and radial plane labelled (A) which points away from the axis of rotation (C). The first end (5) and the second end (6) are shown in part. The first surface (2) of the filter medium is oriented in a plane which is parallel to the radial plane (A) when the filter is in operation. The arrow labelled (B) shows the direction of the flow of the feed as it passes through the filter medium (1). The side wall (3) has an interior surface (4) on which solid material will accumulate during the operation of the filter. When the filter is operating and rotating about the axis of rotation (C) any solid material accumulating on said first surface (2) is centripetally urged along and ultimately away from the first surface (2) of the filter medium. Thus, a filter as shown in FIG. 2) will tend to self-clean the first surface (2) and the solid material will instead tend to accumulate on the interior surface (4) of the side wall (3). Preferably, the flow of the feed (not shown) over the first surface (2) of the filter medium follows the arrow labelled (A) and is parallel to a radial plane in a direction away from the axis of rotation.

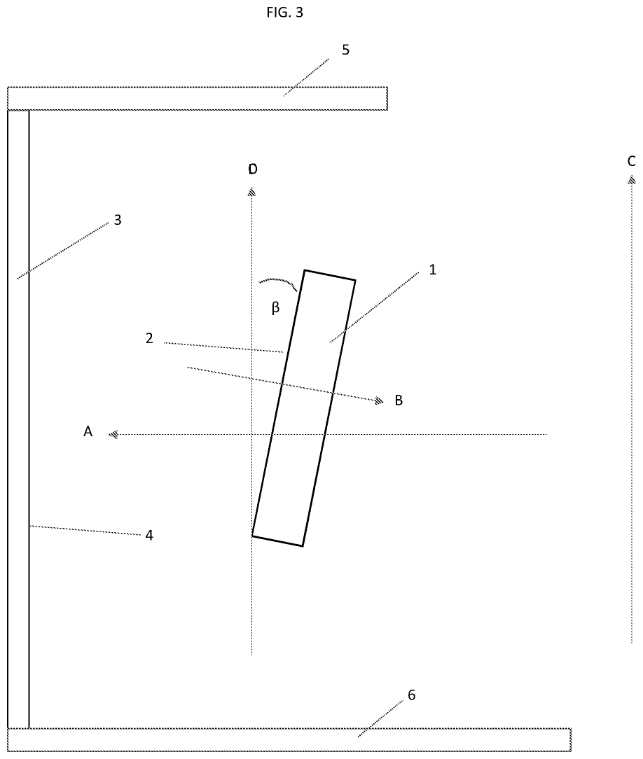

FIG. 3 shows a schematic representation of the orientation of the first surface of the filter medium in part of a cross-section of a filter where the first surface faces the side wall of the filter.

FIG. 3 shows the filter medium (1) and the first surface (2). The first end (5) and the second end (6) are shown in part. The filter medium has a first surface (2) which is oriented with an angle β with respect to the arrow (D) which is parallel to the axis of rotation labelled as arrow (C). The first surface (2) of the filter medium is oriented such that it faces at the side wall (3). The side wall (3) has an interior surface (4) on which solid material will accumulate during operation of the filter. When the filter is operating and rotating about the axis of rotation (C) solid material accumulating on said first surface (2) is centripetally urged away from the first surface (2) of the filter medium. Thus, a filter as shown in FIG. 3) will tend to self-clean the first surface (2) and the solid material will instead tend to accumulate on the interior surface (4) of the side walls (3). The arrow labelled (B) shows the direction of the feed as it passes through the filter medium (1). The arrow labelled (A) shows a radial plane as it extends away from the axis of rotation (C).

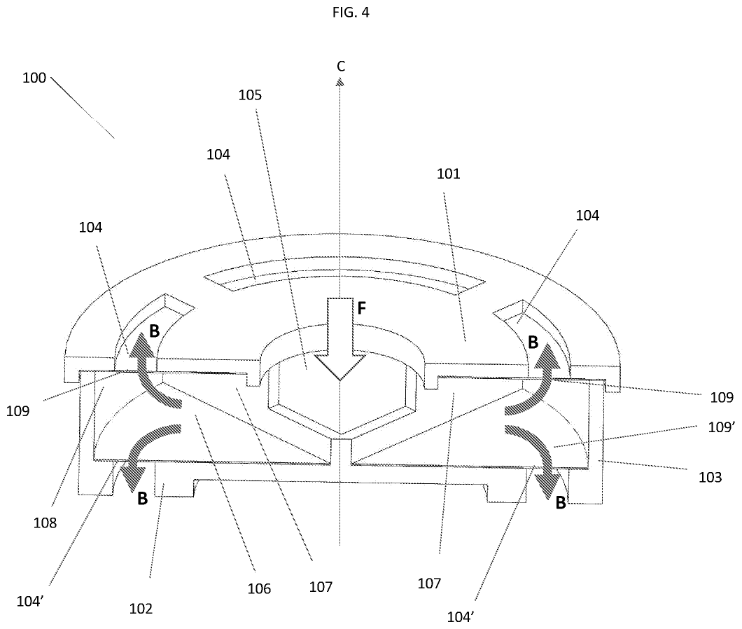

FIG. 4 shows a 3D cross-section view of a filter (100) according to the present invention The filter is cylindrical in shape.

The filter (100) has a first end (101), a second end (102) and a side wall (103). The first end (101) and second end (102) are substantially circular and the side wall (103) is cylindrical. The cylindrical side wall (103) has no perforations. The axis of rotation during the operation of the filter is shown by the line (C). The filter (100) has four equally spaced filter media (104) located in the first end (101), one of which is shown in full and two are shown in part, and four filter media (104′) located in the second end (102). The filter media (104, 104′) are located further away from the axis of rotation (C) and more towards the outmost circumference of the first end (101) or second end (102). The filter media (104, 104′) serve as outlets from the filter (100). The filter media (104, 104′) are planar and have a first surface (109, 109′) which is oriented in a plane parallel to a radial plane. The first end (101) has an inlet (105) located axially and through which a feed (shown by arrow F) is able to enter the filter chamber (106). The filter (100) has an impeller with four flat blades (107) projecting outwardly from the axis of rotation, two of which are shown. Rotation of the filter (100) causes the feed to travel from the filter chamber and out through the filter medium (104, 104′, shown by arrow B). In use solid material accumulates preferentially on the interior surface (108) of the side wall (103). Solid material which would otherwise have accumulated on the surface (109, 109′) of the filter medium (104, 104′) through which the feed passes is centripetally urged towards the interior surface (108) of the side wall (103) as the filter (100) is rotated during operation. The first end (102) is detachable from the side wall (103) and the second end (101) and when the filter (100) needs cleaning this detachability provides for easy access and cleaning out of the accumulated solid material.

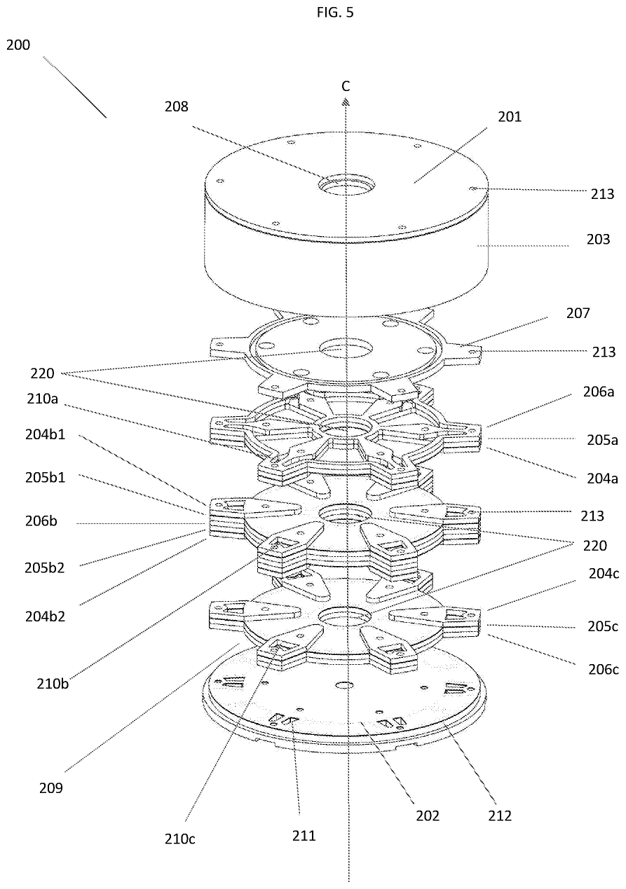

FIG. 5 shows an exploded isometric view of an alternative filter (200) with many of the layers of the filter separated and partially disassembled. The filter is cylindrical in shape.

The filter has a first end (201), a second end (202) and a side wall (203). The first end (201) and second end (202) are substantially circular and the side wall (203) is cylindrical. The first end (201), second end (202) and side wall (203) form the filter chamber. The cylindrical side wall (203) has no perforations. The filter (200) comprises a plurality of filter media which are planar, which are located on filter supports which take the form of discs. The combination of filter media and supports are called a filter layer (204a, 204b1, 204b2 and 204c) and these filter layers (204a, 204b1, 204b2 and 204c) are stacked with their centres along the axis of rotation. The first surfaces of the filter media through which the feed passes are oriented in a plane which is parallel to a radial plane.

The filter (200) comprises substantially disc-shaped impeller layers (205a, 205b1, 205b2 and 205c), disc-shaped directing layers (206a, 206b and 206c) and a top layer (207) which terminates the layers nearest the first end (201). Each impeller layer comprises six blades. The filter layers (204a, 204b1, 204b2 and 204c), impeller layers (205a, 205b1, 205b2 and 205c), directing layers (206a, 206b and 206c) and top layer (207) are stacked in the filter (200). The first end (201) an inlet (208) located axially and through which the feed is able to enter the filter chamber. Each layer (207, 206a,b,c, 205a,b1,b2,c, and 204a,b1,b2,c) has an axial aperture (220) located along the axis of rotation (C) which permits feed entering the filter chamber to flow to the filter media within the filter (200). Each of the layers (207, 206a,b,c, 205a,b1,b2,c, and 204a,b1,b2,c) has a cut-out portion (209) towards the circumference of the disc which are aligned. These cut-out portions (209) provide regions around the interior surface (not shown) of the side wall (203) in which the solid material can accumulate without blocking the flow of the feed as it passes through the filter. Each layer (206a,b,c, 205a,b1,b2,c, and 204a,b1,b2,c), with the exception of the top layer (207), is provided with apertures (210a, 210b, 210c) which are located proximate to the side wall, around the circumference of each layer. These apertures are aligned when the layers are stacked to form a common portion of the flow path which permits feed having passed through the filter media to readily exit the filter (200) via twelve flow path outlets (211) in the second end (202), eight of which are shown in FIG. 5. Surfaces of the filter media through which feed enters the filter (200) are spaced permitting the flow of the liquid and the movement of accumulating solid material.

During the operation of the filter (200), solid material accumulates in the regions created by the cut-out portions (209) of the layers and on the interior surface of the side wall (203). Solid material which would otherwise have tended to accumulate on the first surface of the filter medium through which the feed passes is centripetally urged away from the first surface and radially outwards towards the side wall (203). In this way the filter (200) is “self-cleaning” during operation and rotation.

Openings (213) in the layers and the first and second end (201, 202) provide a means to align the layers and to lock the layers and filter components together using guide rods (not shown). A seal in the form of an O-ring (212) is provided in the second end (202) such that it is readily detachable from the first end (201) and side wall (203).

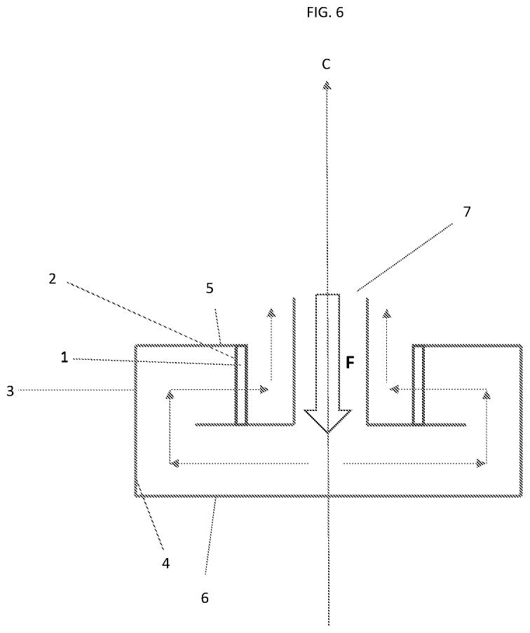

FIG. 6 is an illustration of a cross-section of an alternative filter according to the present invention. The filter is cylindrical in shape.

The filter has a filter medium (1) having a first surface (2) which surrounds the axis of rotation (C). The side wall (3) is cylindrical and has an internal surface (4) and no perforations. The side wall (3) is attached to a substantially circular first end (5) and a substantially circular second end (6). An inlet (7) in the first end (1) permits feed (shown by arrow F) to enter the filter during operation. When in use and the filter is rotated the small arrows show the direction of the flow of the feed. The first surface (2) faces the side wall (3). The first surface (2) is oriented so as to be parallel to the axis of rotation (C) and parallel to the side wall (3). The filter medium (1) also acts as the outlet for the filter.

In use the filter is rotated and feed enters the filter chamber (shown by arrow F). The feed passes through the filter medium (1). The filter medium (1) is oriented such that when the filter is operating and rotating about the axis of rotation (C) any solid material accumulating on the first surface (2) is urged away from the first surface (2). The solid material tends to accumulate on the interior surface (4) of the side wall (3) which have no perforations. In this way the filter is “self-cleaning” during operation and rotation.

General

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The following are numbered clauses of the invention:

1. A filter suitable for a filter unit, the filter being rotatable around an axis of rotation, the filter comprising:

a) a first end, a second end and one or more side walls connecting the first end of the filter and the second end of the filter, wherein the first end, second end and one or more side walls of the filter define a filter chamber;

b) an inlet located in the first end of the filter, wherein said inlet is configured to allow a feed to enter the filter chamber;

c) a filter medium having a first surface, wherein the first surface is the surface through which the feed enters the filter medium and is filtered; and

wherein one or more of the following requirements are met:

i) at least a portion of said first surface is oriented such that when the filter is operating and rotating about the axis of rotation any solid material accumulating on said first surface is urged away from said first surface;

ii) at least one of the side walls of the filter has perforations provided that no more than 50% of the surface area of said at least one side wall is occupied by said perforations;

iii) the filter additionally comprises a flow path which is defined and constrained by one or more surfaces within the filter chamber, said flow path having at least a portion which is not coincident with the axis of rotation of the filter during operation nor is it radial with regard to the axis of rotation during operation;

iv) the filter comprises a plurality of filter media, at least some of which are stacked in layers.

2. A filter according to clause 1 wherein at least a portion of said first surface is oriented such that when the filter is operating and rotating about the axis of rotation any solid material accumulating on said first surface is urged away from the first surface.
3. A filter according to clause 1 or 2 wherein at least a portion of said first surface is oriented in a plane which is no more than 50 degrees from a radial plane when the filter is in operation.
4. A filter according to clause 3 wherein at least a portion of said first surface is oriented in a plane which is no more than 20 degrees from a radial plane when the filter is in operation.
5. A filter according to clause 3 or 4 wherein the portion is at least 50% of said surface area of said first surface.
6. A filter according to any one of clauses 3 to 5 wherein during operation the feed flows over said first surface in a direction flowing away from the axis of rotation and towards the one or more side walls.
7. A filter according to any one of the preceding clauses wherein said first surface is planar.
8. A filter according to any one of the preceding clauses wherein the filter medium is planar.
9. A filter according to any one of the preceding clauses wherein at least one of the side walls of the filter has perforations provided that no more than 50% of the surface area of said at least one side wall is occupied by said perforations.
10. A filter according to clause 9 wherein at least one of the side walls of the filter has perforations provided that no more than 10% of the surface area of said at least one side wall is occupied by said perforations.
11. A filter according to clause 10 having two or more side walls, wherein two or more of the side walls of the filter have perforations provided that in totality no more than 10% of the total surface area of all of the side walls are occupied by said perforations.
12. A filter according to any one of clauses 9 to 11 wherein no side wall present has perforations.
13. A filter according to any one of clauses 1 to 12 wherein the one or more side walls are attached to the first end; and the second end is detachable from the one or more side walls.
14. A filter according to any one of the preceding clauses comprising one or more regions where during operation of said filter, solid material present in the feed can accumulate on an interior surface of the one or more side walls.
15. A filter according to any one of the preceding clauses which additionally comprises a flow path which is defined and constrained by one or more surfaces within the filter chamber, said flow path having at least a portion which is not coincident with the axis of rotation of the filter during operation nor is it radial with regard to the axis of rotation during operation.
16. A filter according to clause 15 wherein at least a portion of the flow path is defined and constrained by one or more surfaces in the form of channels, tubes, pipes and the like.
17. A filter according to clause 15 or 16 wherein the flow path terminates with a flow path outlet in the filter.
18. A filter according to clause 17 wherein the flow path outlet in the filter is located in the second end of the filter.
19. A filter according to any one of clauses 15 to 18 wherein the flow path is not defined and constrained by one or more surfaces which include the interior surface of any of the side walls.
20. A filter according to any one of clauses 15 to 19 wherein the flow path is separated from the one or more side walls and from the axis of rotation of the filter.
21. A filter according to any one of clauses 15 to 20 wherein the flow path is configured such that when in operation filtered feed flowing along the flow path will not disturb solid material which has accumulated on the interior surface of the one or more side walls.
22. A filter according to any one of clauses 15 to 21 which comprises a plurality of filter media, and a plurality of flow paths, each flow path being associated with a filter media.
23. A filter according to clause 22 wherein at least a portion of the plurality of flow paths is common and ends in a shared flow path outlet in the filter.
24. A filter according to any one of the preceding clauses which comprises a plurality of filter media, at least some of which are stacked in layers.
25. A filter according to clause 24 wherein the filter media in the stacked layers are all of the same shape, preferably wherein the shapes are selected from those having a planar, corrugated, concave and convex shape.
26. A filter according to clause 25 wherein filter media in the stacked layers all have a planar shape.
27. A filter according to any one of clauses 24 to 26 comprising at least four filter media which are stacked in layers.
28. A filter according to any one of the preceding clauses wherein requirements i. and ii. are met.
29. A filter according to clause 28 wherein requirements i., ii. and iii. are met.
30. A filter according to clause 29 wherein requirements i., ii., iii., and iv. are met.
31. A filter according to any one of the preceding clauses wherein the filter medium comprises perforations, optionally wherein said perforations have an average largest dimension of no more than 1 mm.
32. A filter according to any one of the preceding clauses having a filter medium located in the first and/or second end of the filter, or having a further filter medium located in the first and/or second end of the filter.
33. A filter unit comprising a filter according to any one of the preceding clauses.
34. A filter unit according to clause 33 wherein the filter unit comprises a filter unit housing, a drive means for rotating the filter around an axis of rotation, a housing inlet which during use allows feed to enter the filter unit and a housing outlet which during use allows feed to exit the filter unit.
35. A filter unit according to clauses 33 or 34 which is water-tight.
36. A filter unit according to clause 34 which has one or more openings in the filter unit housing other than the housing inlet and housing outlet.
37. A treatment apparatus, for treating a substrate with a treatment formulation comprising a liquid, the treatment apparatus comprising a drum for rotating the substrate and the treatment formulation, a drive means for rotating the drum and a filter according to any one of clauses 1 to 32 or a filter unit according to any one of clauses 33 to 36.
38. A treatment apparatus according to clause 37 which is a washing machine, a textile treatment machine or a tanning machine.
39. A method of filtering a feed comprising solid material in the form of particles and a liquid, the method comprising using a filter according to any one of clauses 1 to 32 or a filter unit according to any one of clauses 33 to 36 and rotating the filter whilst the feed flows through the filter.
40. A method of filtering a feed according to clause 39 wherein the particles are or comprise fibres.
41. A method of filtering a feed according to clause 40 wherein at least some of said fibres have a longest linear dimension of from 1 μm to 1 mm.
42. A method of filtering a feed according to clause 40 or 41 wherein the fibres are derived from a substrate which has been treated in a treatment formulation comprising liquid.
43. Use of a filter according to any one of clauses 1 to 32 or a filter unit according to any one of clauses 33 to 36 for filtering a feed.

1. A filter suitable for a filter unit, the filter being rotatable around an axis of rotation, the filter comprising:
a) a first end, a second end and one or more side walls connecting the first end of the filter and the second end of the filter, wherein the first end, second end and one or more side walls of the filter define a filter chamber;
b) an inlet located in the first end of the filter, wherein said inlet is configured to allow a feed to enter the filter chamber;
c) a filter medium having a first surface, wherein the first surface is the surface through which the feed enters the filter medium and is filtered; and
wherein at least requirements i) and iv) are met:
i) at least a portion of said first surface is oriented such that when the filter is operating and rotating about the axis of rotation any solid material accumulating on said first surface is urged away from said first surface;
ii) at least one of the side walls of the filter has perforations provided that no more than 50% of the surface area of said at least one side wall is occupied by said perforations;
iii) the filter additionally comprises a flow path which is defined and constrained by one or more surfaces within the filter chamber, said flow path having at least a portion which is not coincident with the axis of rotation of the filter during operation nor is it radial with regard to the axis of rotation during operation;
iv) the filter comprises a plurality of filter media, at least some of which are stacked in layers.

2. A filter according to claim 1 wherein at least a portion of said first surface is oriented in a plane which is no more than 50 degrees from a radial plane when the filter is in operation.

3. A filter according to claim 2 wherein at least a portion of said first surface is oriented in a plane which is no more than 20 degrees from a radial plane when the filter is in operation.

4. A filter according to claim 2 or 3 wherein the portion is at least 50% of said surface area of said first surface.

5. A filter according to any one of claims 2 to 4 wherein during operation the feed flows over said first surface in a direction flowing away from the axis of rotation and towards the one or more side walls.

6. A filter according to any one of the preceding claims wherein said first surface is planar.

7. A filter according to any one of the preceding claims wherein the filter medium is planar.

8. A filter according to any one of the preceding claims wherein requirement ii) is additionally met.

9. A filter according to claim 8 wherein at least one of the side walls of the filter has perforations provided that no more than 10% of the surface area of said at least one side wall is occupied by said perforations.

10. A filter according to claim 9 having two or more side walls, wherein two or more of the side walls of the filter have perforations provided that in totality no more than 10% of the total surface area of all of the side walls are occupied by said perforations.

11. A filter according to any one of claims 8 to 10 wherein no side wall present has perforations.

12. A filter according to any one of claims 1 to 11 wherein the one or more side walls are attached to the first end; and the second end is detachable from the one or more side walls.

13. A filter according to any one of the preceding claims comprising one or more regions where during operation of said filter, solid material present in the feed can accumulate on an interior surface of the one or more side walls.

14. A filter according to any one of the preceding claims wherein requirement iii) is additionally met.

15. A filter according to claim 14 wherein at least a portion of the flow path is defined and constrained by one or more surfaces in the form of channels, tubes, pipes and the like.

16. A filter according to claim 14 or 15 wherein the flow path terminates with a flow path outlet in the filter.

17. A filter according to claim 16 wherein the flow path outlet in the filter is located in the second end of the filter.

18. A filter according to any one of claims 14 to 17 wherein the flow path is not defined and constrained by one or more surfaces which include the interior surface of any of the side walls.

19. A filter according to any one of claims 14 to 18 wherein the flow path is separated from the one or more side walls and from the axis of rotation of the filter.

20. A filter according to any one of claims 14 to 19 wherein the flow path is configured such that when in operation filtered feed flowing along the flow path will not disturb solid material which has accumulated on the interior surface of the one or more side walls.

21. A filter according to any one of claims 14 to 20 which comprises a plurality of filter media, and a plurality of flow paths, each flow path being associated with a filter media.

22. A filter according to claim 21 wherein at least a portion of the plurality of flow paths is common and ends in a shared flow path outlet in the filter.

23. A filter according to any one of the preceding claims wherein the filter media in the stacked layers are all of the same shape, preferably wherein the shapes are selected from those having a planar, corrugated, concave and convex shape.

24. A filter according to claim 23 wherein filter media in the stacked layers all have a planar shape.

25. A filter according to any one of the preceding claims comprising at least four filter media which are stacked in layers.

26. A filter according to any one of the preceding claims wherein the filter medium comprises perforations, optionally wherein said perforations have an average largest dimension of no more than 1 mm.

27. A filter according to any one of the preceding claims having a filter medium located in the first and/or second end of the filter, or having a further filter medium located in the first and/or second end of the filter.

28. A filter unit comprising a filter according to any one of the preceding claims.

29. A filter unit according to claim 28 wherein the filter unit comprises a filter unit housing, a drive means for rotating the filter around an axis of rotation, a housing inlet which during use allows feed to enter the filter unit and a housing outlet which during use allows feed to exit the filter unit.

30. A filter unit according to claim 28 or 29 which is water-tight.

31. A filter unit according to claim 28 which has one or more openings in the filter unit housing other than the housing inlet and housing outlet.

32. A treatment apparatus, for treating a substrate with a treatment formulation comprising a liquid, the treatment apparatus comprising a drum for rotating the substrate and the treatment formulation, a drive means for rotating the drum and a filter according to any one of claims 1 to 27 or a filter unit according to any one of claims 28 to 31.

33. A treatment apparatus according to claim 32 which is a washing machine, a textile treatment machine or a tanning machine.

34. A method of filtering a feed comprising solid material in the form of particles and a liquid, the method comprising using a filter according to any one of claims 1 to 27 or a filter unit according to any one of claims 28 to 31 and rotating the filter whilst the feed flows through the filter.

35. A method of filtering a feed according to claim 34 wherein the particles are or comprise fibres.

36. A method of filtering a feed according to claim 35 wherein at least some of said fibres have a longest linear dimension of from 1 μm to 1 mm.

37. A method of filtering a feed according to claim 35 or 36 wherein the fibres are derived from a substrate which has been treated in a treatment formulation comprising liquid.

38. Use of a filter according to any one of claims 1 to 27 or a filter unit according to any one of claims 28 to 31 for filtering a feed.
